(19) United States
(12) Patent Application Publication
(10) Pub. No.: US 2004/0054688 A1
(43) Pub. Date: Mar. 18, 2004

(54) Method and apparatus for controlling component list in issue tracking system

(75) Inventor: Trung M. Tran, Round Rock, TX (US)

Correspondence Address: David B. Ritchie, Thelen Reid & Priest LLP, P. O. Box 640640, San Jose, CA, 95164-0640, US

(73) Assignee: Sun Microsystems, Inc., a Delaware Corporation

(21) Appl. No.: 10/245,762

(22) Filed: Sep. 16, 2002

(51) Int. Cl. G06F 7/00

(52) U.S. Cl. 707/104.1

(57) ABSTRACT

A method for controlling a component list of an issue tracking system, including (a) maintaining a component list in a database, (b) providing access to the component list to an authorized user, the providing access including permitting the authorized user to download the component list, modify the component list, and upload the modified component list back to the database, (c) providing access to the system to a submitter of an issue report relating to a component, the providing the access to the system including permitting the submitter to download the component list from the database, and (d) updating the downloaded component list for the submitter without terminating the access to the system.

### FIELD OF THE INVENTION

The present invention relates to the field of issue tracking system. More particularly, the present invention relates to a method and apparatus for controlling a component list in an issue tracking system.

### BACKGROUND AND RELATED ART

An issue tracking system is a software tool typically having a graphic user interface (GUI), and allows product or service designers to keep track of problems or issues related to their specific works. An issue tracking system is also referred to as a defect tracking system, a bug tracking system, or the like. Products, manufacturing or design processes, and services typically include various parts, portions, stages of processes and/or functions. Also, there are many people and parties involving such products, producing processes, and services. For example, an integrated circuit (IC) design process includes various steps performed by different designer groups or projects specialized in a specific function, such as functional design, logic design, logic verification, circuit design, circuit verification, layout, layout verification, and the like. Most vendors/providers of software or hardware products provide their customers with technical support services for trouble shooting and/or maintenance of the products.

When a problem or issue related to a specific function/parts is found, such a problem can be reported using an issue/defect tracking tool, so that a responsible person is notified of the problem and solves the problem. A defect tracking tool manages such reports from, for example, customers, and makes necessary information available to a person or persons responsible for specific issues or problems. Typically, the reported issues and problems are categorized and stored in a database. A category of issues and problems is referred to as a component. Thus, a list of components or component names (a component list) must be defined before the issue tracking system is installed. Users report issues and problems to the tracking system using the defined component names, so that the tracking system can categorize the received reports.

A number of different groups or projects may be involved in a large enterprise such as the entire design process handled by an issue tracking system. Each group/project may want to have a specific set of component names or sub-component names because of the project's specific needs. For examples, layout designers are only interested in layout and circuit problems, whereas verification designers may need to see network, compiler, licenses, CAD, and the like in their component list. Therefore, the conventional pre-defined and pre-loaded component list may not provide sufficient control of problems and issues for all of the projects or groups.

### BRIEF DESCRIPTION OF THE INVENTION

A method for controlling a component list of an issue tracking system, including (a) maintaining a component list in a database, (b) providing access to the component list to an authorized user, the providing access including permitting the authorized user to download the component list, modify the component list, and upload the modified component list back to the database, (c) providing access to the system to a submitter of an issue report relating to a component, the providing the access to the system including permitting the submitter to download the component list from the database, and (d) updating the downloaded component list for the submitter without terminating the access to the system.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram schematically illustrating a computer system suitable for implementing aspects of the present invention.

FIG. 2 is a block diagram schematically illustrating an issue tracking system in accordance with one embodiment of the present invention.

FIG. 3A is a diagram schematically illustrating an example of the component list in accordance with one embodiment of the present invention.

FIG. 3B is a diagram schematically illustrating another example of the component list in accordance with one embodiment of the present invention.

FIG. 4 is a diagram schematically illustrating an example of a display screen for submitting an issue report in accordance with one embodiment of the present invention.

FIG. 5A is a diagram schematically illustrating an example of a selection window for the component in accordance with one embodiment of the present invention.

FIG. 5B is a diagram schematically illustrating an example of a selected component and the contact information of a responsible entity displayed on a screen in accordance with one embodiment of the present invention.

FIGS. 6A-6C are diagrams schematically illustrating an example of display screens for the responsible entity in accordance with one embodiment of the present invention.

FIG. 7 is a diagram schematically illustrating an example of a command button for refreshing the component list in accordance with one embodiment of the present invention.

FIG. 8 is a process flow diagram schematically illustrating a method for controlling a component list of an issue tracking system in accordance with one embodiment of the present invention.

### DETAILED DESCRIPTION

Embodiments of the present invention are described herein in the context of a method and apparatus for controlling a component list in an issue tracking system. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In accordance with one embodiment of the present invention, the method may be implemented on a data processing computer such as a personal computer, workstation computer, mainframe computer, or high performance server running an OS such as Solaris® available from Sun Microsystems, Inc. of Palo Alto, Calif., Microsoft® Windows® XP and Windows® 2000, available form Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

In the context of the present invention, the term “network” includes local area networks (LANs), wide area networks (WANs), the Internet, cable television systems, telephone systems, wireless telecommunications systems, fiber optic networks, ATM networks, frame relay networks, satellite communications systems, and the like. Such networks are well known in the art and consequently are not further described here.

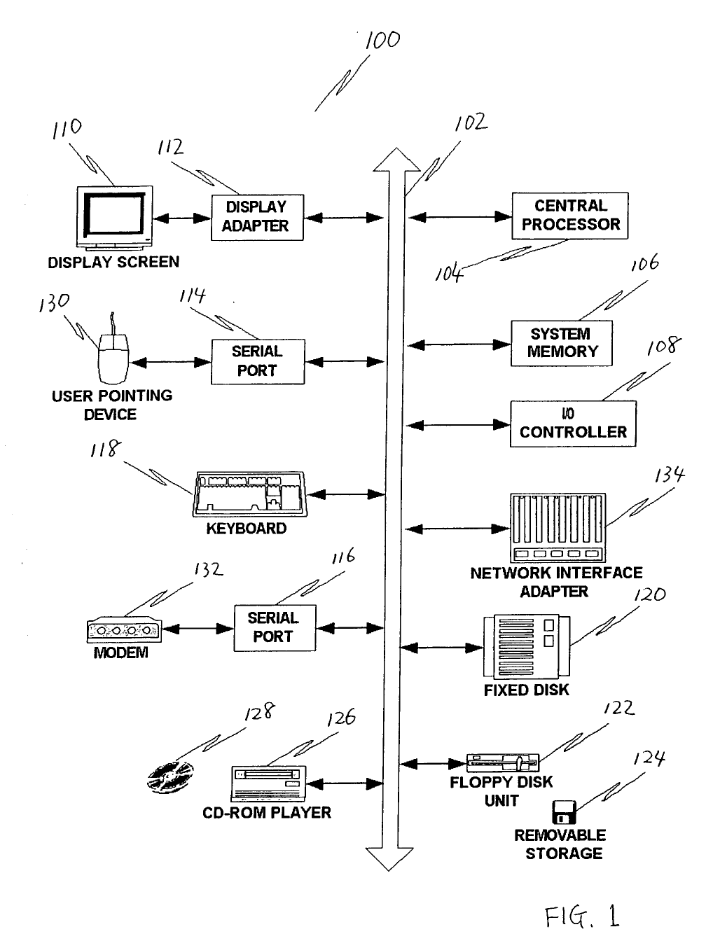

FIG. 1 depicts a block diagram of a computer system 100 suitable for implementing aspects of the present invention. As shown in FIG. 1, computer system 100 includes a bus 102 which interconnects major subsystems such as a central processor 104, a system memory 106 (typically RAM), an input/output (I/O) controller 108, an external device such as a display screen 110 via display adapter 112, serial ports 114 and 116, a keyboard 118, a fixed disk drive 120, a floppy disk drive 122 operative to receive a floppy disk 124, and a CD-ROM player 126 operative to receive a CD-ROM 128. Many other devices can be connected, such as a pointing device 130 (e.g., a mouse) connected via serial port 114 and a modem 132 connected via serial port 116. Modem 132 may provide a direct connection to a remote server via a telephone link or to the Internet via a POP (point of presence). Alternatively, a network interface adapter 134 may be used to interface to a local or wide area network using any network interface system known to those skilled in the art (e.g., Ethernet, xDSL, AppleTalkTM).

Many other devices or subsystems (not shown) may be connected in a similar manner. Also, it is not necessary for all of the devices shown in FIG. 1 to be present to practice the present invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion. Code to implement the present invention may be operably disposed in system memory 106 or stored on storage media such as fixed disk 120, floppy disk 124 or CD-ROM 128.

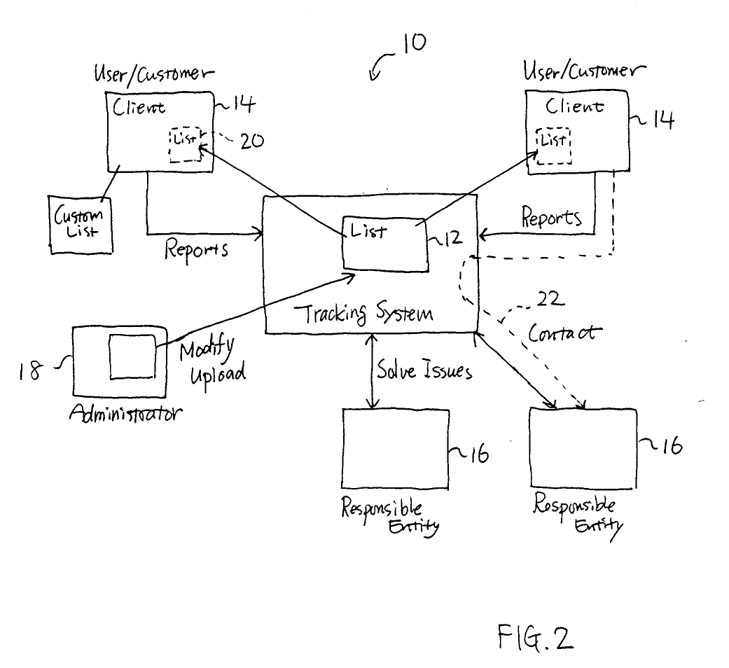

FIG. 2 schematically illustrates an issue tracking system 10 in accordance with one embodiment of the present invention. The tracking system 10 includes a component list 12 maintained in a database. A component defines a category of issues to be handled by the issue tracking system. A component list contains a list of components and contact information of at least one responsible entity. The responsible entity is a person (or a group of persons) who is responsible to solve or fix the problem reported. Such contact information may be an email address and/or phone number.

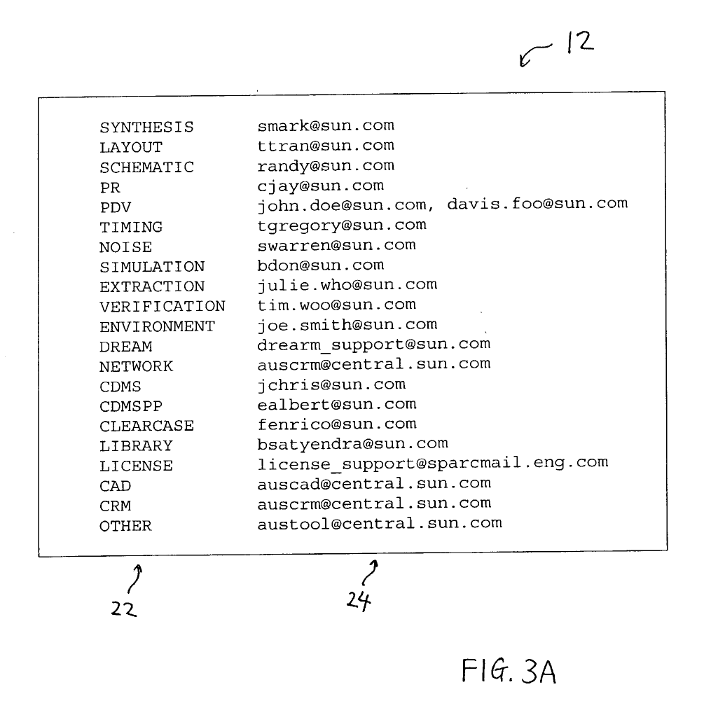

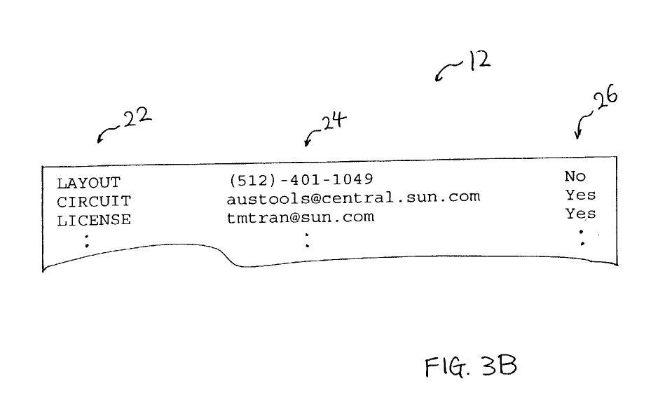

FIG. 3A schematically illustrates an example of the component list 12. The first column 22 of the list 12 contains the component names, and the second column 24 contains the responsible persons' email addresses as the contact information. The second column may list user identification if the system knows the contact information by the user IDs. The tracking system 10 uses the contact information to send email to the responsible entity when an issue or problem is reported (opened) against the corresponding component. Optionally, as shown in FIG. 3B, the component list 12 may also include a third column 26 to allow the issue tracking system 10 to send back an acknowledgement (typically, via email) when an issue is opened or received by the responsible entity 16. For components having “Yes” (or any other flag indicating the need of acknowledgement) in the third column 26, the system 10 automatically sends an acknowledgement to the user/customer 14 when the reported issue is opened.

Referring back to FIG. 2, a user/customer 14, a responsible entity 16 for the component, and an authorized user 18 are involved in the issue tracking system 10. Typically, there are a number of user/customers 14 and responsible entities 16. The user/customer 14 is a submitter of an issue report relating a component. For example, the user/customer 14 reports an issue (such as problem, defect, bug, and the like) of a specific component to the tracking system 10. The issue reports may be electronically submitted via email, or via any type of computer network. The issues may also be reported using telephone system (personal conversation, automated answering system, and the like) or using other non-electronic medium, and input to the tracking system 10 automatically, or manually. The received issue reports are stored in a database categorized under the component names.

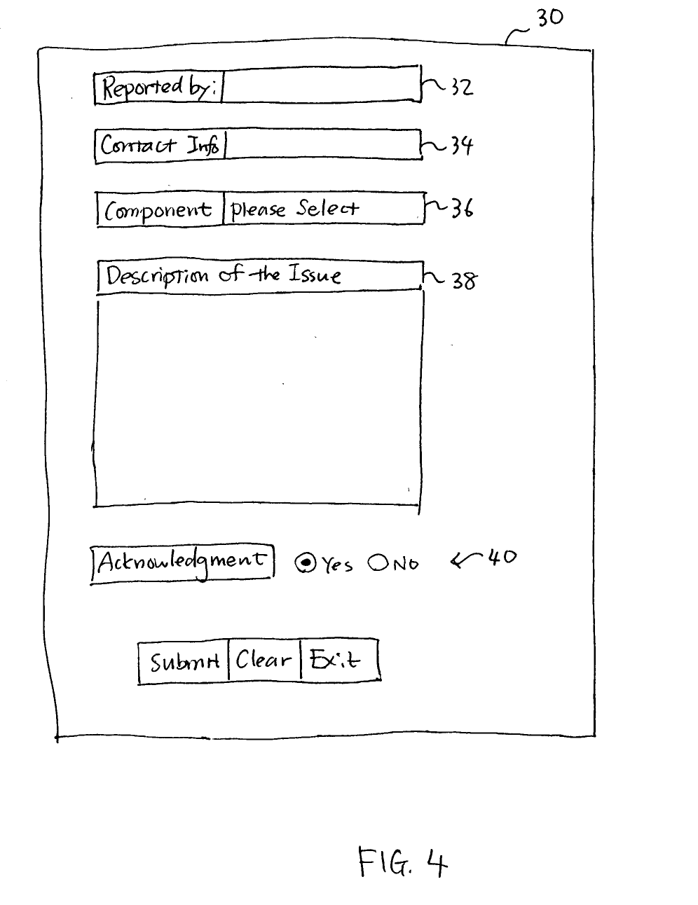

In accordance with one embodiment of the invention, the user/customer 14 uses a GUI to create and submit an issue report. For example, when a user/customer 14 has a problem with a component, he/she starts the program which may display a issue report screen. FIG. 4 schematically illustrates an example of a display screen 30 for submitting an issue report. As shown in FIG. 4, the display screen 30 may include a space for inputting the reporter's identification (a user name, user ID, email address, or the like) 32, contact information 34 (typically email address or phone number) of the user, component name 36, brief description of the issue or problem 38, and the like. The reported date and other information may be automatically stamped to the issue report. If the user/customer 14 uses an email system to submit the issue report, the user's contact information (email address) may be automatically attached to the issue report without requesting the user input.

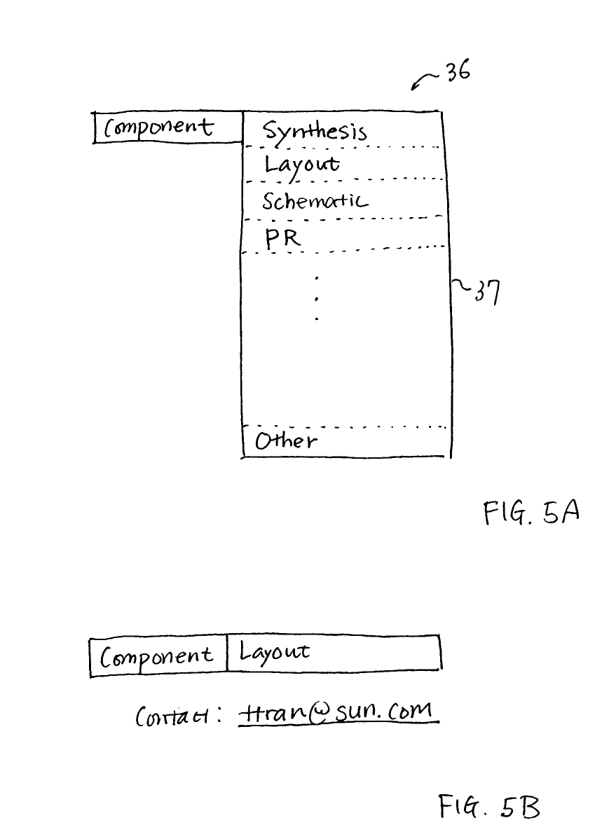

The component name is typically input by selecting one component from a component list presented to the user/customer. The tracking system allows the user/customer 14 to download the component list 12 from the database (as shown in FIG. 2). The component list is at least once downloaded when the tool is first installed. The component list may be presented for the user's selection in a pull-down window. FIG. 5A schematically illustrates an example of such a selection window 37 for the component space 36. The component list may be presented using any type of pop-up window or the like. The user/customer 14 may select a component name by double-clicking or any other pointing action. When a component is selected, the contact information of the responsible entity for that component may be displayed, for example, as shown in FIG. 5B. This gives the user/customer an option to contact the responsible entity 16 directly, or through the tracking system 10

Referring back to FIG. 4, the user/customer 14 then describes the problem (issue) regarding the component in a given space 38. Optionally, the display screen 30 may ask if the user/customer wants an acknowledgement when the issue is received or opened by the responsible entity 16. For example, the display screen may include yes/no buttons 40 for requesting the acknowledgement.

The submitted issue reports are stored in a database of the tracking system 10, categorized by the component names. Issue identification information such as an issue number may be assigned to each issue. If the user/customer chooses an option to directly contact the responsible entity, such contact 22 (typically email, phone call, or voice mail) may also be provided. The tracking system 10 may also notify the responsible entity 16 when an issue report is received, so that the responsible entity can access the system database to retrieve the issue report and perform necessary action.

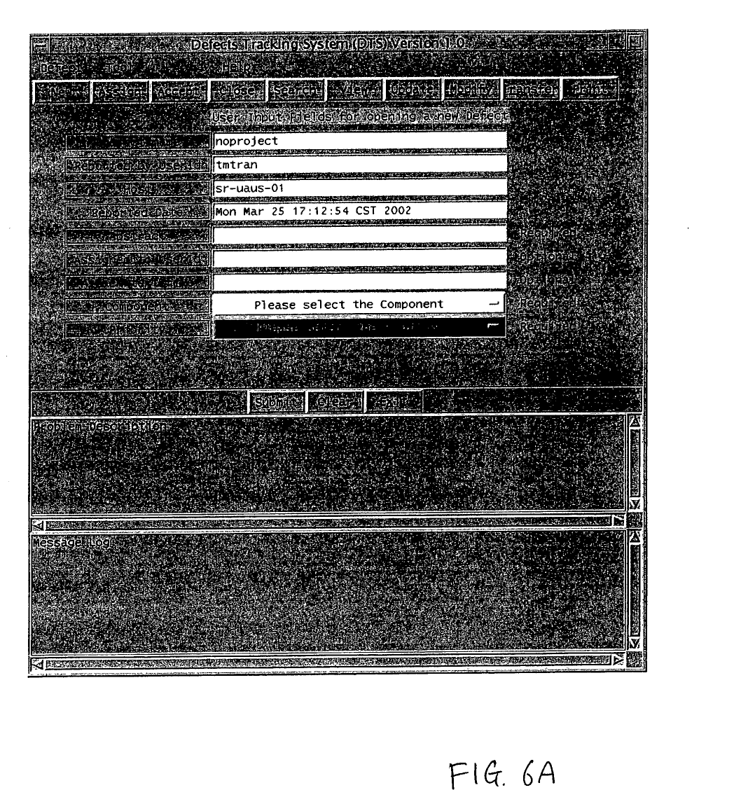

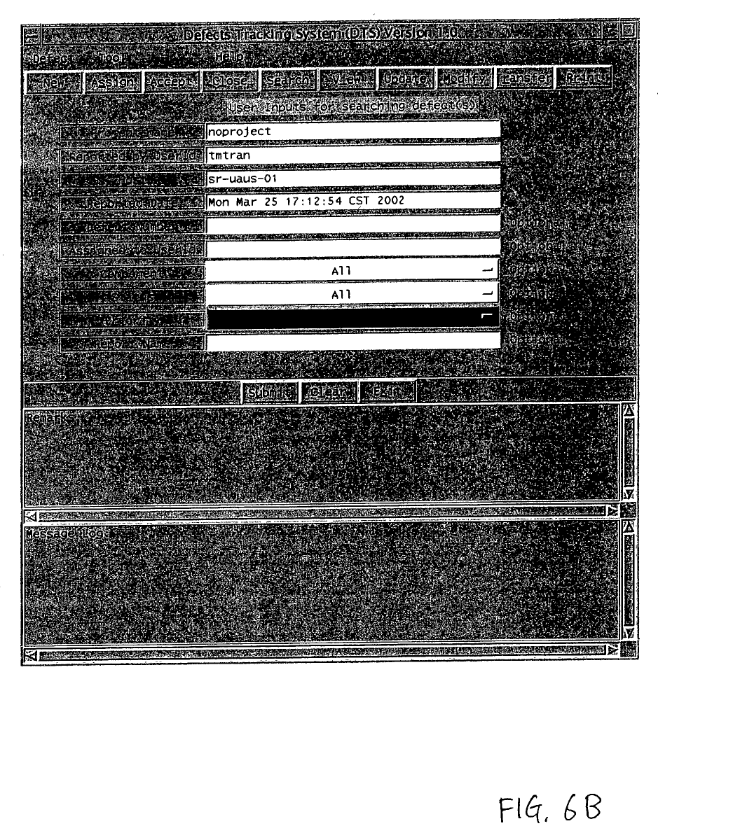

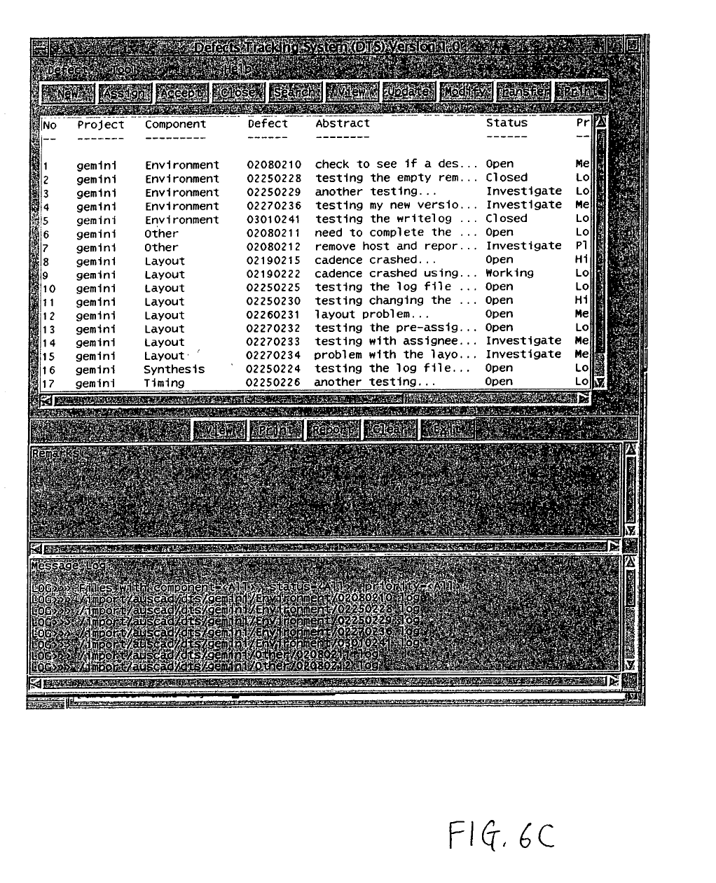

The responsible entity 16 is a person (or group) who solves the issue and fixes the problem. The responsible entity 16 typically accesses the database containing the issue reports, opens an issue to be solved, performs necessary actions, and then reports the results to the system 10. The status of the issue may be updated during the course of the solving the problem. FIGS. 6A-6C depict an example of display screens for the responsible entity 16. FIG. 6A shows a screen for opening a new issue/problem. In order to select an issue to be solved, the responsible entity may use a search function of the system. FIG. 6B depicts an example of an input screen for searching issue(s)/defect(s). As shown in FIG. 6B, the responsible entity may specify one or more of the component name, issue number, status of the issue, priority, and the like. The component name list may be displayed in a component selection box. FIG. 6C illustrates an example of a search result screen. From these screens, the responsible entity can conduct various actions such as viewing the issue report, printing, updating, modifying, assigning, transferring, reporting the result of solving the issue, and the like.

Referring back to FIG. 2, the authorized user 18 is typically an administrator of the tracking system 10, and has a privileged access to the system 10. The authorized user 18 is not only permitted to download the component list from the database, but also modify the component list and upload the modified component list back to the database. Such a privileged access may require a specific authorization such as a password. The component list may be used by several projects or groups, and each project or group may have its specific concern. For example, in an IC design process, layout designers are typically interested in problems related to specific components such as Layout and Circuit and they only need to have two components on their component list, while verification designers may need to have components such as Network, Compiler, License, CAD, and the like on their component lists. New components may have to be added to the original component list due to a change in the project or request from customers. For example, the component list displayed to the usr/customer may contain an additional component “Other.” The system administrator may add a new component by categorizing similar issues and problems submitted under the “Other” component.

As described above, conventionally, the component list for a specific issue tracking system is predefined and fixed when the tracking system is set up for a specific set of components, for example, various stages of a design flow for an IC chip, various parts for a specific automobile design, functions provided by computer software, operative parts of an electronic device, and the like. The user/customer downloads the original component list of the system when the tool is loaded or deployed on the user/customer's machine. The downloaded component list is typically stored locally for the tool's future use. Thus, in a conventional issue tracking system, if the original component list has been modified and the component list on the user/customer-side needs to be updated, the user/customer-side tool must be terminated and restarted in order to reload the modified list. That is, the user/customer must log-off from the system to update the component list. However, in accordance with one embodiment of the present invention, the user/customer can update the component list without terminating the access to the tracking system.

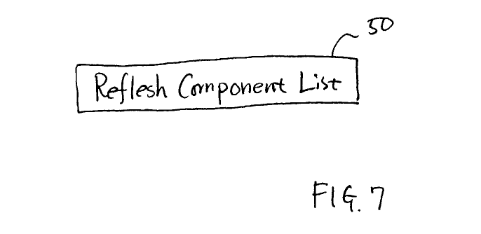

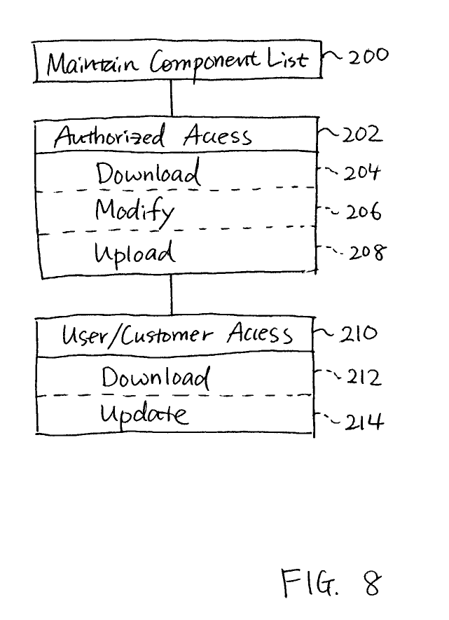

In accordance with one embodiment of the present invention, the component list on the user/customer side is updated upon the user/customer request. For example, as shown in FIG. 7, a command button 50 (such as “Refresh Component List”) may be provided on an issue-report screen for the user/customer. Alternatively, the component list may be updated periodically at a selected time. Typically, the original component list of the tracking system 10 is stored in a selected directory of the database, for example, the Home directory. When the original component list is modified by the administrator, the modified list is also stored in the same directory. Thus, when updating the component list, the user/customer tool may download the modified component list from that specific directory.

In accordance with one embodiment of the present invention, the tracking system 10 also allows the user/customer 14 to customize the component list. For example, as described above, some users/customers may need only a subset of the component list, and others may want to have sub-components under one or more exiting component names. In addition, the responsible entities 16 may also have similar requests for component management from their point of view. If a requested customization is only limiting the view of existing components to be displayed on the user/customer screen, such customization may be done by the user/customer. However, general customization of the component list is done though the administrator 18. Once a customized component is created, it is stored in a selected place (e.g., specific directory or the like). There may be a plurality of customized component lists stored in respective places.

When a user/customer 14 specifies using the customized component list, the component list for that user/customer is obtained by loading the customized component list from the selected place. For example, the user/customer may specify using the customized list by selecting a component list option provided on the screen, which may create a link to the specific space (or directory) where the customized list is stored. If the user/customer 14 does not specify the customized component list, the component list for the user/customer is obtained from the database where the general (original/modified) component list for the tracking system is stored (typically from the Home directory). In addition, a default place (e.g., default directory or the like) may be prepared for storing a default (typically the original) component list. If no component list is found in the database (e.g., the Home directory), the component list for the user/customer 14 is loaded from the default place.

In accordance with one embodiment of the present invention, the tracking system 10 employs a predetermined string format for creating and storing the component list 12. When an administrator 18 or authorized user enters component names to create a component list or to modify/customize an existing component list, the tracking system automatically converts the component names into a predetermined string format. For example, such a string format may have an upper case for the first letter only. This feature avoids creating two different names in the list and two different directory names in the database when two names are only different in upper/lower cases. For example, all “Layout,” “LAYOUT,” “LayOut,” and “LaYouT,” which may be used by different people or groups, are treated as the same component name, and the component name appears as “Layout” on the list.

FIG. 8 schematically illustrates a method for controlling a component list of an issue tracking system in accordance with one embodiment of the present invention. First, a component list is created and maintained in a database (200). An authorized user is provided with access to the component list (202), which includes permission to download the component list (204), modify the component list (206), and upload the modified component list back to the database (208). A submitter (user/customer) of an issue report is also provided with access to the system (210), which includes permission to download the component list from the database (212). Update of the downloaded component list for the submitter is performed without terminating the submitter's access to the system (214).

As described above, the issue tracking system in accordance with one embodiments of the present invention is easy-to-use, robust, and has a dynamic component list which can be updated without terminating the system. The issue tracking system allows users to create their own component lists to define the component names (i.e., categories of issues) and associated component owners (i.e., responsible entities). The system also provides users options and/or priorities to obtain a customized, modified/original, or default component list. The system employs a predetermined string format so as to avoid double listing the same component or creating duplicated directories in the database.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for controlling a component list of an issue tracking system, comprising:
maintaining a component list in a database;
providing access to the component list to an authorized user, said providing access including permitting the authorized user to download the component list, modify the component list, and upload the modified component list back to the database;
providing access to the system to a submitter of an issue report relating to a component, said providing the access to the system including permitting the submitter to download the component list from the database; and
updating the downloaded component list for the submitter without terminating the access to the system.

2. The method in accordance with claim 1 wherein said providing access to the system further includes:
allowing the user to select a component from the component list.

3. The method in accordance with claim 1 wherein the component list includes:
component names; and
information of an entity responsible for each component.

4. The method in accordance with claim 3 wherein said information includes at least one of an email address and a telephone number of the responsible entity.

5. The method in accordance with claim 3 wherein said providing access to the system further includes:
providing the user with an option to contact the responsible entity.

6. The method in accordance with claim 3 wherein the component list further includes:
indication of need of an acknowledgement to be sent to the submitter.

7. The method in accordance with claim 6, further comprising:
sending an acknowledgement to the submitter if the issue reported is opened.

8. The method in accordance with claim 1 wherein said providing access to the system further includes:
allowing the submitter to customize the component list in response to the submitter's request; and
storing the customized list.

9. The method in accordance with claim 8 wherein said providing access to the system further includes:
loading the customized component list if the submitter specifies the customized component list; and
loading the component list from the database if the submitter does not specify the customized list.

10. The method in accordance with claim 9 wherein said providing access to the system further includes:
loading a default component list if the component list is not found in the database.

11. The method in accordance with claim 1 wherein said updating is performed in response to a request from the submitter.

12. The method in accordance with claim 1 wherein said updating is performed periodically.

13. The method in accordance with claim 1, further comprising:
converting a component name entered by the authorized user into a predetermined string format.

14. An apparatus for controlling a component list of an issue tracking system, comprising:
means for maintaining a component list in a database;
means for providing access to the component list to an authorized user, said means for providing access including means for permitting the authorized user to download the component list, modify the component list to form a modified component list, and upload the modified component list back to the database;
means for providing access to the system to a submitter of an issue report relating to a component, said means for providing the access to the system including means for permitting the submitter to download the component list from the database; and
means for updating the downloaded component list for the submitter without terminating the access to the system.

15. The apparatus in accordance with claim 14 wherein said means for providing access to the system further includes:
means for allowing the user to select a component from the component list.

16. The apparatus in accordance with claim 14 wherein the component list includes:
component names; and
information of an entity responsible for each component.

17. The apparatus in accordance with claim 16 wherein said information includes at least one of an email address and a telephone number of the responsible entity.

18. The apparatus in accordance with claim 16 wherein said means for providing access to the system further includes:
means for providing the user with an option to contact the responsible entity.

19. The apparatus in accordance with claim 16 wherein the component list further includes:
indication of need of an acknowledgement to be sent to the submitter.

20. The apparatus in accordance with claim 19, further comprising:
means for sending an acknowledgement to the submitter if the issue reported is opened.

21. The apparatus in accordance with claim 14 wherein said means for providing access to the system further includes:
means for allowing the submitter to customize the component list in response to the submitter's request; and
means for storing the customized list.

22. The apparatus in accordance with claim 21 wherein said means for providing access to the system further includes:
means for loading the customized component list if the submitter specifies the customized component list; and
means for loading the component list from the database if the submitter does not specify the customized list.

23. The apparatus in accordance with claim 22 wherein said means for providing access to the system further includes:
means for loading a default component list if the component list is not found in the database.

24. The apparatus in accordance with claim 14 wherein said means for updating performs the update in response to a request from the submitter.

25. The apparatus in accordance with claim 14 wherein said means for updating performs the update periodically.

26. The apparatus in accordance with claim 14, further comprising:
means for converting a component name entered by the authorized user into a predetermined string format.

27. A program storage device readable by a machine, tangibly embodying a program of instructions executable by the machine to perform a method for controlling a component list of an issue tracking system, the method comprising:
maintaining a component list in a database;
providing access to the component list to an authorized user, said providing access including permitting the authorized user to download the component list, modify the component list to form a modified component list, and upload the modified component list back to the database;
providing access to the system to a submitter of an issue report relating to a component, said providing the access to the system including permitting the submitter to download the component list from the database; and
updating the downloaded component list for the submitter without terminating the access to the system.
